(19) United States
(12) Patent Application Publication
(10) Pub. No.: US 2021/0220914 A1
(43) Pub. Date: Jul. 22, 2021

(54) FUGITIVE PHASES IN INFILTRATION

(71) Applicant: Desktop Metal, Inc., urlington, MA (US)

(72) Inventors: Ellen Elizabeth Benn, Cambridge, MA (US); Michael Andrew Gibson, Boston, MA (US); Emanuel Michael Sachs, Newton, MA (US)

(73) Assignee: Desktop Metal, Inc., Burlington, MA (US)

(21) Appl. No.: 17/254,288

(22) PCT Filed: Jul. 19, 2019
(86) PCT No.: PCT/US2019/042629

§ 371 Date: Dec. 20, 2020

Related U.S. Application Data
(60) Provisional application No. 62/701,263, filed on Jul. 20, 2018.

(51) Int. Cl. B22F 10/14; B22F 10/43; B22F 3/22; B22F 3/26; B33Y 10/00; B33Y 40/20; B33Y 70/00; B33Y 80/00

(52) U.S. Cl. CPC B22F 10/14; B22F 10/43; B22F 3/225; B22F 3/26; B22F 2302/20; B33Y 40/20; B33Y 70/00; B33Y 80/00; B33Y 10/00

(57) ABSTRACT

Disclosed is a method and material system for fabricating metal infiltrated objects having a high volume fraction of infiltrant relative to the infiltrated preform. In an embodiment method, a composite is formed into the shape of a desired object, the composite including a skeletal phase and a fugitive phase. The fugitive phase is then removed to create a self-supporting porous skeletal structure. The porous skeletal structure is then infiltrated with the infiltrant to achieve a densified object.

### FIELD OF THE DISCLOSURE

The subject matter of the present disclosure generally relates to infiltration of objects, and more particularly relates to infiltrated objects with a high volumetric fraction of infiltrant.

### BACKGROUND OF THE DISCLOSURE

Metal infiltration is a processing technique by which a porous preform is infiltrated with a liquid infiltrant of a different metal or alloy to fill void space in the preform to create a final densified part. There are various material systems for the preform material and the infiltrant that are known in the art. It is desirable in certain instances to fabricate a preform for infiltration using three-dimensional printing processes as these processes provide excellent ability to accommodate varying part geometries, rapid prototyping and generally avoid the need for molds, which are expensive and limit part geometry.

In infiltrated structures, the infiltrant and the preform material often have fairly different mechanical properties because the infiltrant typically must have a lower melting point than the preform to avoid dissolving the preform. Thus, the infiltrant is usually of lower strength, hardness and/or stiffness. As a result, the properties of the resulting material are dictated largely by the ratio of the two phases—the ratio of the infiltrant phase to the preform phase. Unfortunately, it is often difficult to independently control the ratio of the two phases when formulating the preform using additive manufacturing processes for reasons now described.

Take for example the infiltration of a preform fabricated using a powder bed additive manufacturing process. To form the preform powders are spread layer-by-layer, with binder jetted from a print head to define the preform geometry. After the preform is formed, loose powder around the preform is removed and much of the binder is removed. In an emblematic aluminum-aluminum infiltration system, the aluminum preform is then nitrided to form an aluminum nitride skeleton. The aluminum nitride preform may then be infiltrated with liquid aluminum, which has a lower melting temperature than the aluminum nitride. This nitriding and infiltration process is described in U.S. Pat. No. 7,036,550 entitled “Infiltrated Aluminum Preforms” and filed Mar. 15, 2004, the entire contents of which are incorporated by reference herein.

In a powder bed additive manufacturing process as described above, the apparent density of the powder is the density returned by measuring the volume occupied by a known mass of powder flowed freely into a standardized measuring device. The tap density of the powder is the density returned as the result of flowing an amount of powder into a graduated cylinder which is then mechanically tapped until further volume reduction is minimalized. The volume fraction of the preform material printed will usually, by virtue of the layer-by-layer spreading, fall between the apparent density of the powder and the tap density of the powder.

Some powders can be spread to either above or below this range, but this generally defines the range that can be achieved. For the flowable powders typically used in powder bed additive manufacturing processes, the apparent densities are typically greater than 54 percent by volume, and the tap densities are typically less than 65 percent by volume. This range, 54-65 percent, represents a very small fraction of potential design space and limits the maximum volume fraction of infiltrant. A result of this confined volume fraction range is a confined range of properties that may be achieved by the resulting composites for a given infiltrant and preform composition. It is desirable to be able to engineer a wider range of properties in such composites, and thus techniques to expand the available volume fractions range are desirable.

Similar volume fraction constraints exist for other additive manufacturing techniques such as thermoplastic extrusion of bound metal composites due to rheological concerns and concerns regarding packing and dimensional stability of the structures during the thermal processing required by such methods.

As an example of the result of such difficulties, one may generally not be able to achieve excellent properties of the resultant composite if the properties require the preform to have a volume fraction different than the range from the apparent density to the tap density. For example, in the aluminum-aluminum infiltration system described above, the aluminum nitride has a large difference in mechanical properties as compared to the aluminum infiltrant. Normally, one would tune the properties of the composite by adjusting the volume fraction of each. However, the above described limited volume fraction range restricts the tuning and thus mechanical properties that can be accomplished.

Further techniques and disclosure related to infiltration can be found in U.S. Patent Publication No. 2018/0305266-A1 titled “Additive Fabrication Of Infiltrable Structures” and filed Apr. 24, 2018, the entire contents of which are incorporated herein in their entirety.

The subject matter of the present disclosure is directed to overcoming, or at least reducing the effects of, one or more of the problems set forth above.

### BRIEF SUMMARY OF THE DISCLOSURE

Disclosed is a method and material system for the infiltration of objects where the infiltrated objects have a high infiltrant-to-preform volume ratio compared to previously available infiltrated structures.

This is accomplished using a fugitive phase which is removed prior infiltration. Specifically, a composite is formed into the shape of a desired object, the composite including a skeletal phase and a fugitive phase. The fugitive phase is then removed to create a self-supporting porous skeletal structure. The porous skeletal structure is then infiltrated with the infiltrant to achieve a densified object. The infiltrant occupies the space previously occupied by the fugitive phase and any otherwise porous space when forming the shape of the desired object.

### BRIEF DESCRIPTION OF THE DRAWINGS

The foregoing summary, preferred embodiments, and other aspects of the present disclosure will be best understood with reference to a detailed description of specific embodiments, which follows, when read in conjunction with the accompanying drawings, in which:

FIGS. 1A-C depict a material extrusion system for use in forming a composite into a desired shape.

FIGS. 2A-C depict a powder bed binder jetting system for use in forming a composite into a desired shape.

FIG. 3 is micrograph depiction of the structure of an existing typical powder and binder system as formed into an unfinished part in a metal additive manufacturing process.

FIG. 4 is flowchart diagram of an embodiment method.

FIGS. 5A-5D depict a cross-section view of an object during an embodiment method performed using a material extrusion system.

FIGS. 6A-6D depict a cross-section view of an object during an embodiment method performed using a powder be binder jetting system.

FIG. 7 is micrograph depiction of the structure of a porous skeletal structure after removal of the fugitive phase.

FIG. 8 is micrograph depiction of the structure of a porous skeletal structure after infiltration.

Like reference numbers and designations in the various drawings indicate like elements.

### DETAILED DESCRIPTION

Disclosed is a material system and method for fabricating three-dimensional objects. A metal powder composite is co-fabricated with a fugitive phase. The metal powder material serves the same role as in traditional infiltration processes. However, the fugitive phase is removed prior to infiltration to form a more porous skeletal structure which is then filled by the infiltrant. Thus a higher ratio of infiltrant to metal powder may be achieved than possible without the fugitive phase.

For the purposes of this application, the term “phase” should be understood to have its typical meaning in the field of metallurgy. The term “fugitive phase” for the purposes of this application means a fugitive phase material formed into discrete units that are together removable from a skeletal structure formed form a skeletal metal powder without compromising the mechanical integrity of the skeletal structure.

Formation of the Preform

Described now are several emblematic manufacturing systems and methods with which the present disclosure may be employed to form the initial shape of an object to be infiltrated. For a further description of the processing of the fugitive phase, see the section below entitled “Fugitive Phases for Infiltration.” Generally, any manufacturing technique capable of allowing the formation of a shape of a desired part to be formed from a composite may be employed. Non-limiting examples of additive manufacturing techniques that may be employed include material extrusion, powder bed binder jetting, stereolithographic printing, and selective laser sintering. An example of a material extrusion system for use with the disclosed technology is the Studio system by DESKTOP METAL, INC. of Burlington, Mass. Similarly, a paste extrusion process may use the same materials design philosophy as outlined below, expect that instead of a thermoplastic binder, one may use a paste. An example of a powder bed binder jetting system for use with the disclosed technology is the Production system by DESKTOP METAL, INC. of Burlington, Mass.

Other manufacturing techniques, such as injection of the composite into a mold, may also be employed.

In a powder bed process, these fugitive phases may be admixed into the feed powder prior to spreading, along with the skeletal powder, to create an admixed blend of a skeletal powder and a fugitive phase. Binder jetting or selective laser sintering may then take place as the process normally occurs to bond the powders together for subsequent post-processing.

In a thermoplastic material extrusion process, the fugitive phase may be compounded into the thermoplastic binder system along with the material from which the skeleton will be fabricated.

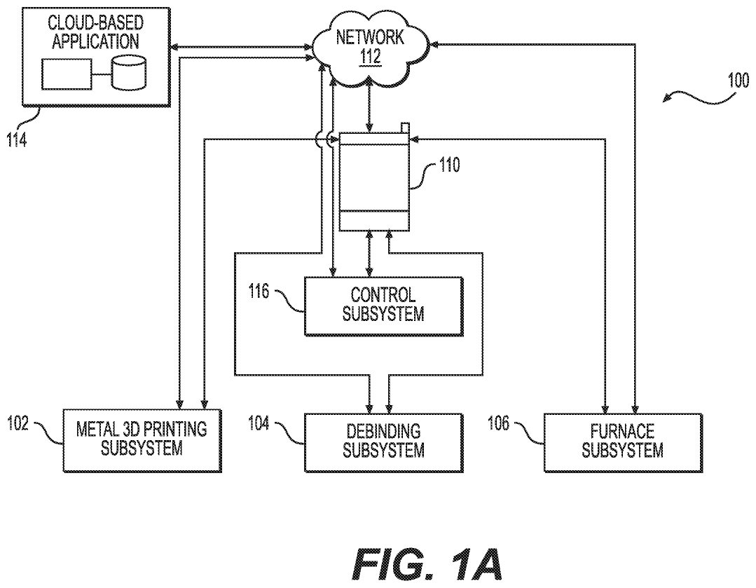

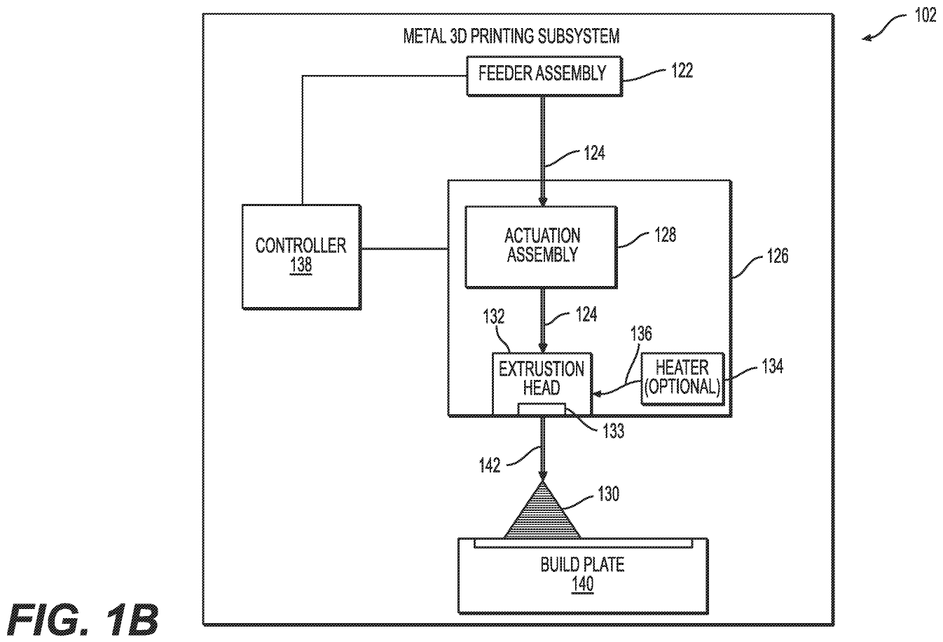

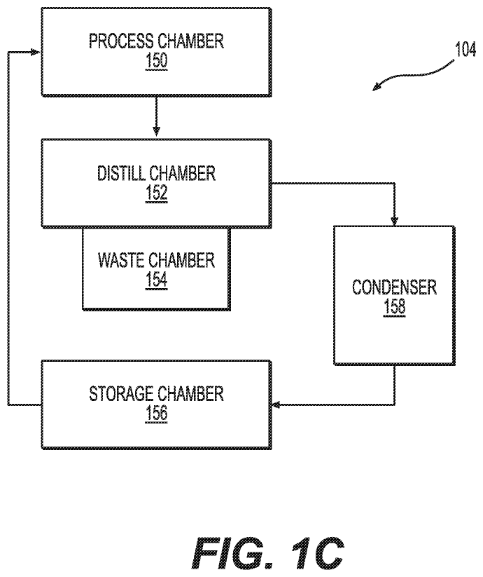

FIG. 1A illustrates an exemplary system 100 for forming a printed object, according to an embodiment of the present disclosure. System 100 may include a three-dimensional (3D) printer, for example, a metal 3D printing subsystem 102, and one or more treatment site(s), for example, a debinding subsystem 104 and a furnace subsystem 106, for treating the green part after printing. Metal 3D printing subsystem 102 may be used to form an object from a build material, for example, by depositing successive layers of the build material onto a build plate. The build material may include metal powder and at least one binder material. In some embodiments, the build material may include a primary binder material (e.g., a wax) and a secondary binder material (e.g., a polymer). A binder system may include a single binder or a primary binder and a secondary binder.

Debinding subsystem 104 may be configured to treat the printed object by performing a first debinding process, in which the primary binder material may be removed. In some embodiments, the first debinding process may be a chemical debinding process, as will be described in further detail with reference to FIG. 1C. In such embodiments, the primary binder material may dissolve in a debinding fluid while the secondary binder material remains, holding the metal particles in place in their printed form.

In other embodiments, the first debinding process may comprise a thermal debinding process. In such embodiments, the primary binder material may have a vaporization temperature lower than that of the secondary binder material. The debinding subsystem 104 may be configured to heat the deposited build material to a temperature at or above the vaporization temperature of the primary binder material and below the vaporization temperature of the secondary binder material such that the primary binder material is removed from the printed part. In alternative embodiments, the furnace subsystem 106 rather than a separate heating debinding subsystem 104 may be configured to perform the first debinding process. For example, the furnace subsystem 106 may be configured to heat the deposited build material to a temperature at or above the vaporization temperature of the primary binder material and below the vaporization temperature of the secondary binder material such that the primary binder material is removed from the deposited build material.

Furnace subsystem 106 may be configured to treat the printed object by performing a secondary thermal debinding process (or also a primary debinding process, as in the alternative embodiment described above), in which the secondary binder material and/or any remaining primary binder material may be vaporized and removed from the printed part. In some embodiments, the secondary debinding process may comprise a thermal debinding process, in which the furnace subsystem 106 may be configured to heat the part to a temperature at or above the vaporization temperature of the secondary binder material to remove the secondary binder material. The furnace subsystem 106 may then heat the part to a temperature just below the melting point of the metal powder to sinter the metal powder and to densify the metal powder into a solid metal part.

As shown in FIG. 1A, system 100 may also include a user interface 110, which may be operatively coupled to one or more components, for example, to metal 3D printing subsystem 102, debinding subsystem 104, and furnace subsystem 106, etc. In some embodiments, user interface 110 may be a remote device (e.g., a computer, a tablet, a smartphone, a laptop, etc.) or an interface incorporated into system 100, e.g., on one or more of the components. User interface 110 may be wired or wirelessly connected to one or more of metal 3D printing subsystem 102, debinding subsystem 104, and/or furnace subsystem 106. System 100 may also include a control subsystem 116, which may be included in user interface 110, or may be a separate element.

Metal 3D printing subsystem 102, debinding subsystem 104, furnace subsystem 106, user interface 110, and/or control subsystem 116 may each be connected to the other components of system 100 directly or via a network 112. Network 112 may include the Internet and may provide communication through one or more computers, servers, and/or handheld mobile devices, including the various components of system 100. For example, network 112 may provide a data transfer connection between the various components, permitting transfer of data including, e.g., part geometries, printing material, one or more support and/or support interface details, printing instructions, binder materials, heating and/or sintering times and temperatures, etc., for one or more parts or one or more parts to be printed.

Moreover, network 112 may be connected to a cloud-based application 114, which may also provide a data transfer connection between the various components and cloud-based application 114 in order to provide a data transfer connection, as discussed above. Cloud-based application 114 may be accessed by a user in a web browser, and may include various instructions, applications, algorithms, methods of operation, preferences, historical data, etc., for forming the part or object to be printed based on the various user-input details. Alternatively or additionally, the various instructions, applications, algorithms, methods of operation, preferences, historical data, etc., may be stored locally on a local server (not shown) or in a storage and/or processing device within or operably coupled to one or more of metal 3D printing subsystem 102, debinding subsystem 104, sintering furnace subsystem 106, user interface 110, and/or control subsystem 116. In this aspect, metal 3D printing subsystem 102, debinding subsystem 104, furnace subsystem 106, user interface 110, and/or control subsystem 116 may be disconnected from the Internet and/or other networks, which may increase security protections for the components of system 100. In either aspect, an additional controller (not shown) may be associated with one or more of metal 3D printing subsystem 102, debinding subsystem 104, and furnace subsystem 106, etc., and may be configured to receive instructions to form the printed object and to instruct one or more components of system 100 to form the printed object.

FIG. 1B is a block diagram of a metal 3D printing subsystem 102 according to one embodiment. The metal 3D printing subsystem 102 may extrude build material 124 to form a three-dimensional part. As described above, the build material may include a mixture of metal powder and binder material. For example, the build material may include any combination of metal powder, plastics, wax, ceramics, polymers, among others. In some embodiments, the build material 124 may come in the form of a rod comprising a predetermined composition of metal powder and one or more binder components (e.g., a primary and a secondary binder).

Metal 3D printing subsystem 102 may include an extrusion assembly 126 comprising an extrusion head 132. Metal 3D printing subsystem 102 may include an actuation assembly 128 configured to propel the build material 124 into the extrusion head 132. For example, the actuation assembly 128 may be configured to propel the build material 124 in a rod form into the extrusion head 132. In some embodiments, the build material 124 may be continuously provided from the feeder assembly 122 to the actuation assembly 128, which in turn propels the build material 124 into the extrusion head 132. In some embodiments, the actuation assembly 128 may employ a linear actuation to continuously grip and/or push the build material 124 from the feeder assembly 122 towards the extrusion head 132.

In some embodiments, the metal 3D printing subsystem 102 includes a heater 134 configured to generate heat 136 such that the build material 124 propelled into the extrusion head 132 may be heated to a workable state. In some embodiments, the heated build material 124 may be extruded through a nozzle 133 to extrude workable build material 142 onto a build plate 140. It is understood that the heater 134 is an exemplary device for generating heat 136, and that heat 136 may be generated in any suitable way, e.g., via friction of the build material 124 interacting with the extrusion assembly 126, in alternative embodiments. While there is one nozzle 133 shown in FIG. 1B, it is understood that the extrusion assembly 126 may comprise more than one nozzle in other embodiments. In some embodiments, the metal 3D printing subsystem 102 may include another extrusion assembly (not shown in FIG. 1B) configured to extrude a non-sintering ceramic material onto the build plate 140.

In some embodiments, the metal 3D printing subsystem 102 comprises a controller 138. The controller 138 may be configured to position the nozzle 133 along an extrusion path relative to the build plate 140 such that the workable build material is deposited on the build plate 140 to fabricate a three dimensional printed object 130. The controller 138 may be configured to manage operation of the metal 3D printing subsystem 102 to fabricate the printed object 130 according to a three-dimensional model. In some embodiments, the controller 138 may be remote or local to the metallic printing subsystem 102. The controller 138 may be a centralized or distributed system. In some embodiments, the controller 138 may be configured to control a feeder assembly 122 to dispense the build material 124. In some embodiments, the controller 138 may be configured to control the extrusion assembly 126, e.g., the actuation assembly 128, the heater 134, the extrusion head 132, and/or the nozzle 133. In some embodiments, the controller 138 may be included in the control subsystem 116.

FIG. 1C depicts a block diagram of a debinder subsystem 104 for debinding a printed object 130 according to one embodiment. The debinder subsystem 104 may include a process chamber 150, into which the printed object 130 may be inserted for a first debinding process. In some embodiments, the first debinding process may be a chemical debinding process. In such embodiments, the debinder subsystem 104 may include a storage chamber 156 to store a volume of debinding fluid, e.g., a solvent, for use in the first debinding process. The storage chamber 156 may comprise a port which may be used to fill, refill, and/or drain the storage chamber 156 with the debinding fluid. In some embodiments, the storage chamber 156 may be removably attached to the debinder subsystem 104. In such embodiments, the storage chamber 156 may be removed and replaced with a replacement storage chamber (not shown in FIG. 1C) to replenish the debinding fluid in the debinding subsystem 104. In some embodiments, the storage chamber 156 may be removed, refilled with debinding fluid, and reattached to the debinding subsystem 104.

The debinding fluid contained in the storage chamber 156 may be directed to the process chamber 150 containing the inserted printed object 130. In some embodiments, the build material that the printed object 130 is formed of may include a primary binder material and a secondary binder material. In some embodiments, the printed object 130 in the process chamber 150 may be submerged in the debinding fluid for a predetermined period of time. In such embodiments, the primary binder material may dissolve in the debinding fluid while the secondary binder material stays intact.

In some embodiments, the debinding fluid containing the dissolved primary binder material (hereinafter referred to as “used debinding fluid”) may be directed to a distill chamber 152. For example, after the first debinding process, the process chamber 150 may be drained of the used debinding fluid, and the used debinding fluid may be directed to the distill chamber 152. In some embodiments, the distill chamber 152 may be configured to distill the used debinding fluid. In some embodiments, the debinding subsystem 104 may further include a waste chamber 154 fluidly coupled to the distill chamber 152. In such embodiments, the waste chamber may collect waste accumulated in the distill chamber 152 as a result of the distillation. In some embodiments, the waste chamber 154 may be removably attached to the debinding subsystem 104 such that the waste chamber 154 may be removed and replaced after a number of distillation cycles. In some embodiments, the debinding subsystem 104 may include a condenser 158 configured to condense vaporized used debinding fluid from the distill chamber 152 and return the debinding fluid back to the storage chamber 156.

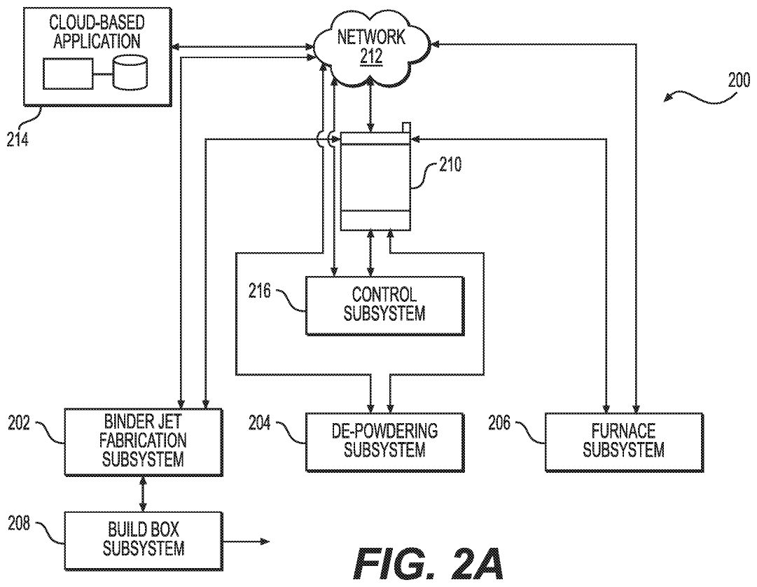

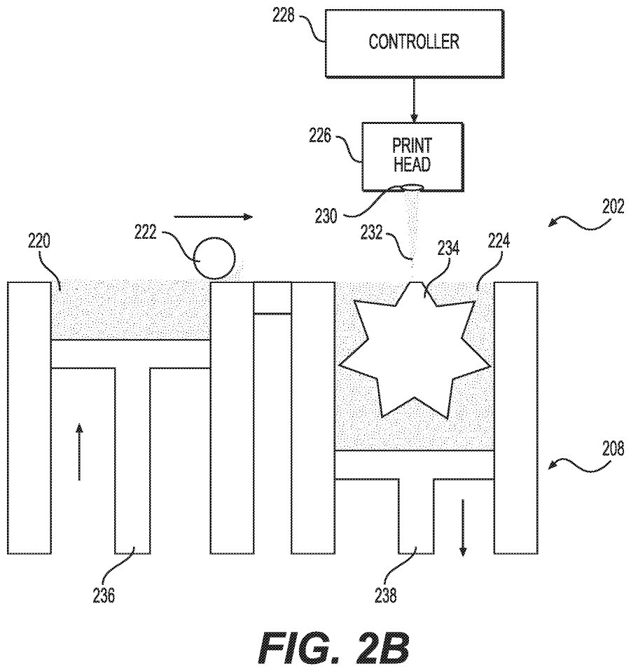

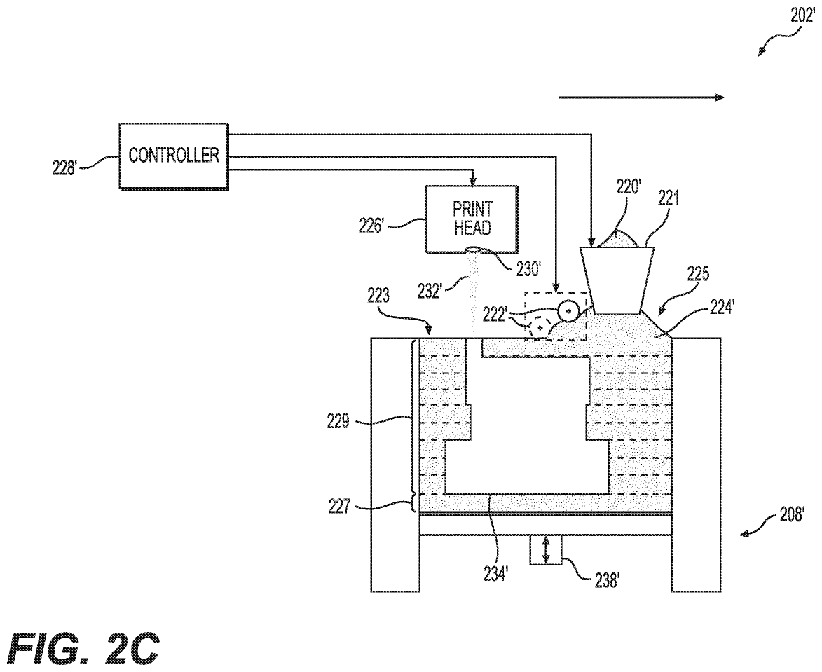

FIG. 2A illustrates another exemplary system 200 for forming a printed object, according to an embodiment of the present disclosure. System 200 may include a printer, for example, a binder jet fabrication subsystem 202, and a treatment site(s), for example, a de-powdering subsystem 204 and the furnace subsystem 106 as described with reference to FIG. 1A. Binder jet fabrication subsystem 202 may be used to form an object from a build material, for example, by delivering successive layers of build material and binder material to a build plate. As shown in FIG. 2A, a build box subsystem 208 may be movable and may be selectively positioned in one or more of binder jet fabrication subsystem 202, de-powdering subsystem 204, and furnace subsystem 106. For example, build box subsystem 208 may be coupled or couplable to a movable assembly. Alternatively, a conveyor (not shown) may help transport the object between portions of system 200.

The build material may be a bulk metallic powder delivered and spread in successive layers. The binder material may be, for example, a polymeric liquid that may be deposited onto and may be absorbed into layers of the build material. One or more of binder jet fabrication subsystem 202, de-powdering subsystem 204, and furnace subsystem 106 may include a shaping station to shape the printed object and a debinding station to treat the printed object to remove a binder material from the build material. Furnace subsystem 106 may heat and/or sinter the build material of the printed object. System 200 may also include a user interface 210, which may be operatively coupled to one or more components, for example, to binder jet fabrication subsystem 202, de-powdering subsystem 204, and furnace subsystem 106, etc. In some embodiments, user interface 210 may be a remote device (e.g., a computer, a tablet, a smartphone, a laptop, etc.). User interface 210 may be wired or wirelessly connected to one or more of binder jet fabrication subsystem 202, de-powdering subsystem 204, and furnace subsystem 106. System 200 may also include a control subsystem 216, which may be included in user interface 210, or may be a separate element.

Binder jet fabrication subsystem 202, de-powdering subsystem 204, furnace subsystem 106, user interface 210, and/or control subsystem 216 may each be connected to the other components of system 200 directly or via a network 212. Network 212 may include the Internet and may provide communication through one or more computers, servers, and/or handheld mobile devices, including the various components of system 200. For example, network 212 may provide a data transfer connection between the various components, permitting transfer of data including, e.g., geometries, the printing material, one or more support and/or support interface details, binder materials, heating and/or sintering times and temperatures, etc., for one or more parts or one or more parts to be printed.

Moreover, network 212 may be connected to a cloud-based application 214, which may also provide a data transfer connection between the various components and cloud-based application 214 in order to provide a data transfer connection, as discussed above. Cloud-based application 214 may be accessed by a user in a web browser, and may include various instructions, applications, algorithms, methods of operation, preferences, historical data, etc., for forming the part or object to be printed based on the various user-input details. Alternatively or additionally, the various instructions, applications, algorithms, methods of operation, preferences, historical data, etc., may be stored locally on a local server (not shown) or in a storage and/or processing device within or operably coupled to one or more of binder jet fabrication subsystem 202, de-powdering subsystem 204, furnace subsystem 106, user interface 210, and/or control subsystem 216. In this aspect, binder jet fabrication subsystem 202, de-powdering subsystem 204, furnace subsystem 106, user interface 210, and/or control subsystem 216 may be disconnected from the Internet and/or other networks, which may increase security protections for the components of system 200. In either aspect, an additional controller (not shown) may be associated with one or more of binder jet fabrication subsystem 202, de-powdering subsystem 204, and furnace subsystem 206, etc., and may be configured to receive instructions to form the printed object and to instruct one or more components of system 200 to form the printed object.

FIG. 2B illustrates an exemplary binder jet fabrication subsystem 202 operating in conjunction with build box subsystem 208. Binder jet fabrication subsystem 202 may include a powder supply 220, a spreader 222 (e.g., a roller) configured to be movable across powder bed 224 of build box subsystem 208, a print head 226 movable across powder bed 224, and a controller 228 in electrical communication (e.g., wireless, wired, Bluetooth, etc.) with print head 226. Powder bed 224 may comprise powder particles, for example, micro-particles of a metal, micro-particles of two or more metals, or a composite of one or more metals and other materials.

Spreader 222 may be movable across powder bed 224 to spread a layer of powder, from powder supply 220, across powder bed 224. Print head 226 may comprise a discharge orifice 230 and, in certain implementations, may be actuated to dispense a binder material 232 (e.g., through delivery of an electric current to a piezoelectric element in mechanical communication with binder material 232) through discharge orifice 230 to the layer of powder spread across powder bed 224. In some embodiments, the binder material 232 may be one or more fluids configured to bind together powder particles.

In operation, controller 228 may actuate print head 226 to deliver binder material 232 from print head 226 to each layer of the powder in a pre-determined two-dimensional pattern, as print head 226 moves across powder bed 224. In embodiments, the movement of print head 226, and the actuation of print head 226 to deliver binder material 232, may be coordinated with movement of spreader 222 across powder bed 224. For example, spreader 222 may spread a layer of the powder across powder bed 224, and print head 226 may deliver the binder in a pre-determined, two-dimensional pattern, to the layer of the powder spread across powder bed 224, to form a layer of one or more three-dimensional objects 234. These steps may be repeated (e.g., with the pre-determined two-dimensional pattern for each respective layer) in sequence to form subsequent layers until, ultimately, the one or more three-dimensional objects 234 are formed in powder bed 224.

Although the example embodiment depicted in FIG. 2B depicts a single object 234 being printed, it should be understood that the powder bed 224 may include more than one object 234 in embodiments in which more than one object 234 is printed at once. Further, the powder bed 224 may be delineated into two or more layers, stacked vertically, with one or more objects disposed within each layer.

An example binder jet fabrication subsystem 202 may comprise a powder supply actuator mechanism 236 that elevates powder supply 220 as spreader 222 layers the powder across powder bed 224. Similarly, build box subsystem 208 may comprise a build box actuator mechanism 238 that lowers powder bed 224 incrementally as each layer of powder is distributed across powder bed 224.

In another example embodiment, layers of powder may be applied to powder bed 224 by a hopper followed by a compaction roller. The hopper may move across powder bed 224, depositing powder along the way. The compaction roller may be configured to follow the hopper, spreading the deposited powder to form a layer of powder.

For example, FIG. 2C illustrates another binder jet fabrication subsystem 202′ operating in conjunction with a build box subsystem 208′. In this aspect, binder jet fabrication subsystem 202′ may include a powder supply 220′ in a metering apparatus, for example, a hopper 221. Binder jet subsystem 202′ may also include one or more spreaders 222′ (e.g., one or more rollers) configured to be movable across powder bed 224′ of build box subsystem 208′, a print head 226′ movable across powder bed 224′, and a controller 228′ in electrical communication (e.g., wireless, wired, Bluetooth, etc.) with one or more of hopper 221, spreaders 222′, and print head 226′. Powder bed 224′ may comprise powder particles, for example, micro-particles of a metal, micro-particles of two or more metals, or a composite of one or more metals and other materials.

Hopper 221 may be any suitable metering apparatus configured to meter and/or deliver powder from powder supply 220′ onto a top surface 223 of powder bed 224′. Hopper 221 may be movable across powder bed 224′ to deliver powder from powder supply 220′ onto top surface 223. The delivered powder may form a pile 225 of powder on top surface 223.

The one or more spreaders 222′ may be movable across powder bed 224′ downstream of hopper 221 to spread powder, e.g., from pile 225, across powder bed 224. The one or more spreaders 222′ may also compact the powder on top surface 223. In either aspect, the one or more spreaders 222′ may form a layer 227 of powder. The aforementioned powder delivery and spreading steps may be successively performed in order to form a plurality of layers 229 of powder. Additionally, although two spreaders 222′ are shown in FIG. 2C, binder jet fabrication subsystem 202′ may include one, three, four, etc. spreaders 222′.

Print head 226′ may comprise one or more discharge orifices 230′ and, in certain implementations, may be actuated to dispense a binder material 232′ (e.g., through delivery of an electric current to a piezoelectric element in mechanical communication with binder material 232′) through discharge orifice 230′ to the layer of powder spread across powder bed 224′. In some embodiments, the binder material 232′ may be one or more fluids configured to bind together powder particles.

In operation, controller 228′ may actuate print head 226′ to deliver binder material 232′ from print head 226′ to each layer 227 of the powder in a pre-determined two-dimensional pattern, as print head 226′ moves across powder bed 224′. As shown in FIG. 2C, controller 228′ may be in communication with hopper 221 and/or the one or more spreaders 222′ as well, for example, to actuate the movement of hopper 221 and the one or more spreaders 222′ across powder bed 224′. Additionally, controller 228′ may control the metering and/or delivery of powder by hopper 221 from powder supply 220 to top surface 223 of powder bed 224′. In embodiments, the movement of print head 226′, and the actuation of print head 226′ to deliver binder material 232′, may be coordinated with movement of hopper 221 and the one or more spreaders 222′ across powder bed 224′. For example, hopper 221 may deliver powder to powder bed 224, and spreader 222′ may spread a layer of the powder across powder bed 224. Then, print head 226 may deliver the binder in a pre-determined, two-dimensional pattern, to the layer of the powder spread across powder bed 224′, to form a layer of one or more three-dimensional objects 234′. These steps may be repeated (e.g., with the pre-determined two-dimensional pattern for each respective layer) in sequence to form subsequent layers until, ultimately, the one or more three-dimensional objects 234′ are formed in powder bed 224′.

Although the example embodiment depicted in FIG. 2C depicts a single object 234′ being printed, it should be understood that the powder bed 224′ may include more than one object 234′ in embodiments in which more than one object 234′ is printed at once. Further, the powder bed 224′ may be delineated into two or more layers 227, stacked vertically, with one or more objects disposed within each layer.

As in FIG. 2B, build box subsystem 208′ may comprise a build box actuator mechanism 238′ that lowers powder bed 224′ incrementally as each layer 227 of powder is distributed across powder bed 224′. Accordingly, hopper 221, the one or more spreaders 222′, and print head 226′ may traverse build box subsystem 208′ at a pre-determined height, and build box actuator mechanism 238′ may lower powder bed 224 to form object 234′.

Although not shown, binder jet fabrication subsystems 202, 202′ may include a coupling interface that may facilitate the coupling and/or uncoupling of the build box subsystems 208, 208′ with the binder jet fabrication subsystems 202, 202′, respectively. The coupling interface may comprise one or more of (i) a mechanical aspect that provides for physical engagement, and/or (ii) an electrical aspect that supports electrical communication between the build box subsystem 208, 208′ to the binder jet fabrication subsystem 202, 202′.

Fugitive Phases in Infiltration

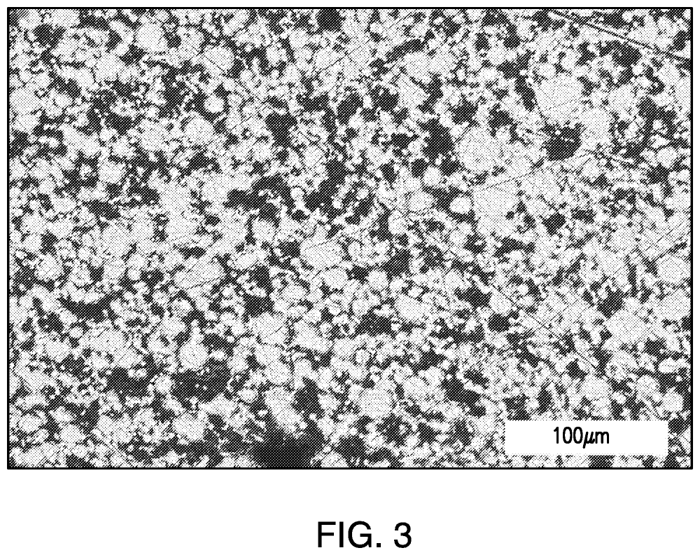

FIG. 3 depicts a micrograph of the structure of typical MIM powder compounded to around tap density. A characteristic of the microstructure is that all the powder particles are touching one another. This structure limits the available volume into which infiltrant can flow.

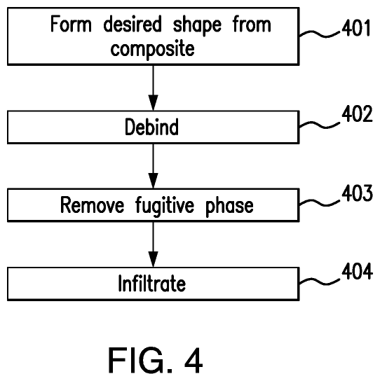

FIG. 4 is a flowchart of an embodiment method to increase the volume fraction of the infiltrant. In step 401, a composite including a skeletal phase and a fugitive phase is formed into the shape of a desired three-dimensional object. In step 402, the binder system is largely removed so that primarily only enough binder remains to maintain the structure of the shape. In step 403, the fugitive phase is removed in a fugitive phase removal process. This forms a porous skeletal structure. In step 404, the porous skeletal structure is infiltrated with the infiltrant to form the final densified three-dimensional object.

It should be noted that the debinding and removal of the fugitive phase may be accomplished during a single step process, for example a combined thermal process that debinds the binder system while simultaneously removing the fugitive phase.

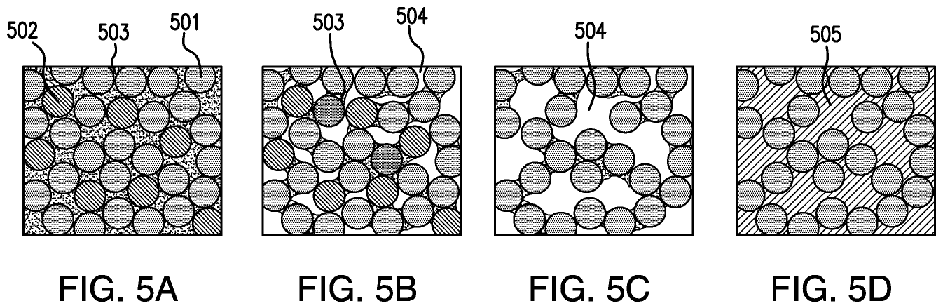

FIG. 5 is a series of schematic illustrations of the steps of the method of FIG. 4 as implemented using a material extrusion process with a binder system of a primary binder and a second binder. FIG. 5A depicts a cross-section of a formed shape of an object including metal powder 501 which is the skeletal phase and the fugitive phase 502. FIG. 5B depicts the cross-section view of FIG. 5A after a debinding process, in which the primary binder has been removed. The secondary binder has necked between the particles of the skeletal phase and the fugitive phase, providing structural support. FIG. 5C then depicts the same view after a fugitive phase removal process, in which the fugitive phase has been removed to create a porous skeletal structure having void space 504. Lastly, FIG. 5D depicts the same view after infiltration of the porous skeletal structure by infiltrant 505. In the embodiment, the secondary binder is eliminated during the infiltration process, but alternatively the secondary binder may continue to exist in the final object.

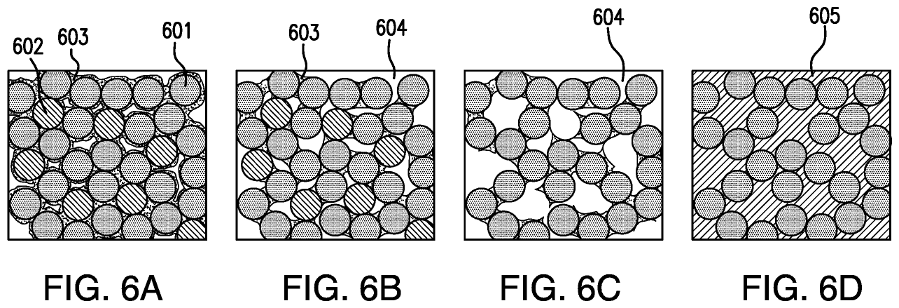

FIG. 6 is a series of schematic illustrations of the steps of the method of FIG. 4 as implemented using a powder bed binder jetting process. FIG. 6A depicts a cross-section of a formed shape of an object including metal powder 601 which is the skeletal phase and the fugitive phase 602. The binder may comprise anywhere between approximately 45%-100% of the void space between the skeletal and fugitive phases. FIG. 6B depicts the cross-section view of FIG. 6A after the binder has dried and necked between the skeletal and fugitive phases. FIG. 6C then depicts the same view after a fugitive phase removal process, in which the fugitive phase has been removed to create a porous skeletal structure having void space 604. Lastly, FIG. 6D depicts the same view after infiltration of the porous skeletal structure by infiltrant 605. It is possible in certain embodiments to remove either the fugitive phase or the binder first in powder bed binder jetting system, such that the order of operations could be reversed for the removal processes described.

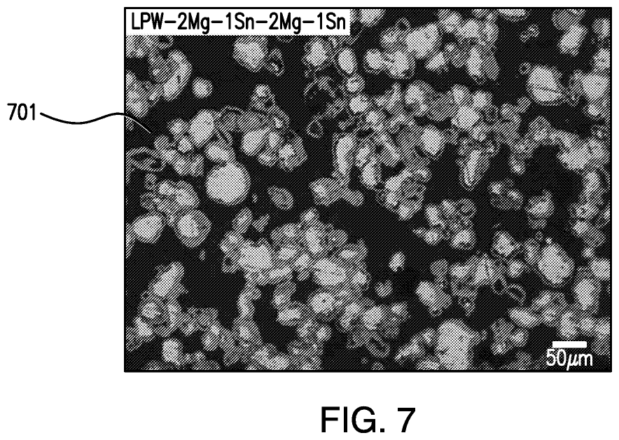

FIG. 7 depicts a micrograph of the porous skeletal structure after removal of the fugitive phase. Unfilled areas 701 include areas previously occupied by the fugitive phase. These areas are then filled with infiltrant during infiltration to increase the volume fraction of infiltrant in the final part. It should be noted that even though there is open space, there is still enough of the non-fugitive phase that the structure is self-supporting. To achieve this, the non-fugitive phase must, at a minimum, be percolated in three-dimensions. The percolation threshold thus sets a rigorous lower bound for the amount of non-fugitive phase. Typically, one may want to have a volume fraction of non-fugitive phase in the compact at least 20% above the volume fraction at the percolation threshold to have a reliable self-supporting structure. For spheres, the percolation threshold in 3D is around 34 percent by volume, so at least 34 vol. % non-fugitive phase if the non-fugitive phase is a sphere. It should further be noted that the percolation threshold is affected by the correlations between particle placement, and that while the percolation threshold for randomly packed objects is a guide, the influence of the packing of the fugitive phase on the percolation may require adjustments in certain embodiments.

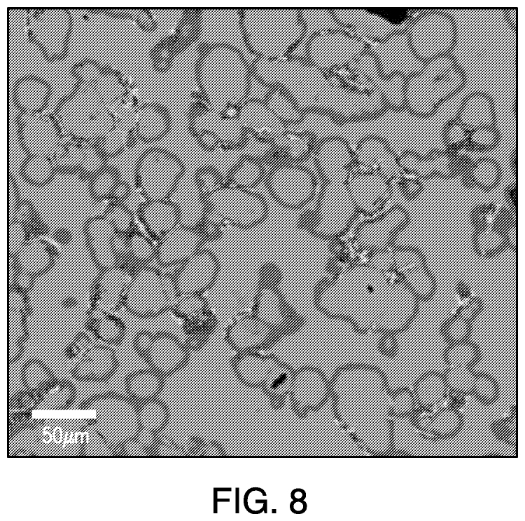

FIG. 8 depicts a micrograph of the porous skeletal structure after infiltration wherein the infiltrant has filled the void space left by the removed fugitive phase and densified the part.

Note that the skeletal material properties are generally defined relative to the infiltrant. A pair of an infiltrant and skeletal metal material may be referred to as the infiltrating material system. The skeletal material will exhibit the properties typical of skeletal materials. For pressure-less infiltration, the skeletal material should be wetting with respect to the infiltrant.

The skeletal material will also generally have a higher melting point than the infiltrant. In some processes, as in the infiltration of aluminum into an aluminum nitride skeleton, a reaction product of the preform material may serve as the skeletal material, which may be originally composed of aluminum substantially free of nitrides.

Another characteristic is that the skeletal material will be dimensionally stable in the presence of the infiltrant in the environments and timescales of the infiltration process. The skeletal material may achieve this through reactions with the environment, for example the reaction of aluminum with nitrogen to form aluminum nitride, or the infiltrant, for example the reaction of carbon-based materials with silicon to form silicon carbide in the infiltration of carbon with silicon. The skeletal material may also achieve dimensional stability by having a melting temperature higher than the infiltration temperature and by limiting reactions with the infiltrant and the environment, for example in the infiltration of stainless steel with bronze.

There are many types of possible fugitive phases, depending on the removal processes used. Different removal processes are described below.

Thermal Removal

In thermal processing, the fugitive phase is caused to evaporate or otherwise become volatile (i.e. through thermal decomposition) by increasing the temperature of the composite material. Examples include, but are not limited to: volatile salts, polymers that thermally decompose with a large volume change and easily-sublimed substances like naphthalene. Polymers that thermally decompose with a large volume change may leave behind a large amount of char (ex: epoxies, poly(acrylic acid), etc.), or may leave behind a relatively low amount of char (ex: poly(propylene), poly(ethylene), poly(vinyl alcohol), and poly(methylmethacrylate), etc.). In some alloy systems, the control of carbon is crucial for achieving excellent material properties, whereas in other systems, additional carbon may not have a strong effect on material properties. In this way, the polymer chosen will be a function of the other materials chosen for the particular infiltration process. Preferred materials systems for fugitive phases in carbon-sensitive systems will be based on the low-char systems, such as poly(methylmethacrylate), or poly(propylene). Such materials may be incorporated as powders into the blend of powder fed into the build material.

Chemical Removal

In chemical processing, the fugitive phase is dissolved in a solvent in which the other components of the printed material are not soluble (i.e. the binder system used and the skeletal material). As a result, the space previously occupied by the fugitive phase is now empty after the chemical processing step. Such fugitive phases may include: soluble salts in water or alcohols, soluble polymers in appropriate solvents, or soluble polymers in supercritical fluids such as paraffin waxes. The choice of the fugitive phase may be made in part based on the residues that would be left over after removal and the compatibility of these residues with the infiltrating system. For example, iron nitrate may be an especially desirable system for use in iron-based systems, whereas compounds of magnesium and/or aluminum may be especially desirable in aluminum or magnesium-based alloys. Example fugitive phases for each of these techniques are below:

Salts soluble in water or alcohols include sodium chloride, potassium chloride, silver chloride, silver nitrate, aluminum nitrate, iron chloride, and iron nitrate.

Polymers soluble in appropriate solvents: include poly(ethylene glycol) in water, paraffin waxes, stearic acid, ethylene vinyl acetate, carnauba waxes, microcrystalline waxes, and others in non-polar solvents including hexane, heptane, n-propyl bromide, perchloroethylene, trans-dichloroethylene, limonene, dichloromethane, and similar solvent-polymer pairs.

Polymers soluble in supercritical fluids include paraffin wax and microcrystalline wax in carbon dioxide.

Thermochemical Removal

Fugitive phases may also be removed through combinations of applied chemicals and heat, as in the decomposition of polyoxymethylene by nitric acid vapors at elevated temperatures resulting in the conversion of the polyoxymethylene polymer into formaldehyde gas (sometimes called catalytic debinding in the field of metal injection molding).

Advantageous Morphologies

There are a number of factors that influence the mechanical properties of the resulting infiltrated part. One is size of the fugitive phase relative to the skeletal phase, or mismatch thereof. Constraints exist based on the fabrication process, the physics of infiltration, and the properties of composites materials derived from specific particle packings.

Constraints from the fabrication process: Many additive fabrication processes involve the deposition of layers. As a general rule, it is preferred for both binder jet additive manufacturing and material extrusion additive manufacturing that the particle size of any solids being deposited be smaller than the layer height, and often substantially smaller than the layer height. As many additive manufacturing processes have layer heights from 50 μm to 250 μm, the upper bound on preferred particle sizes for both species is around 50 to 200 μm, and preferably substantially smaller by at least a factor of two. Finer powders are preferred from the perspective of the surface finish of the part and the homogeneity of the properties for thin sections.

The details of the chemistry and particle size of the fugitive phase should be tailored for the additive manufacturing process used to fabricate the object. For example, in processes based on thermoplastic material extrusion, a design constraint for the polymer fugitive phase is that the fugitive phase exhibits the appropriate morphology after compounding. If a homogeneous dispersion of the fugitive phase is desired with dispersoid sizes of a predictable and tailorable size, one may use a crosslinked polymeric additive with around this desired particle size as an input to the compounding process—e.g. a crosslinked PMMA powder particle. It will be appreciated that some amount of refinement of even crosslinked polymer powder particles may occur during the compounding and extrusion processes, but that this route offers distinct advantages for tailoring the geometric distribution of fugitive phase particles relative to compounding a thermoplastic fugitive phase, and especially a fugitive phase that is miscible or substantially chemically compatible with the rest of the binder system.

Constraints from the physics of infiltration: In most infiltration processes, there is a competition between infiltration kinetics (which favor larger particle sizes), and the driving force for infiltration (which determines the maximal height of the compact that can be infiltrated, and favors smaller particle sizes). Generally, infiltration processes involving metal into powders in powder bed binder jetting applications have favored particle sizes with D50 values between 30 and 80 microns, although many particle size distributions have been used, resulting in infiltration times on the order of tens of minutes-to-hours for preforms with length-scales around 10 mm. Larger compacts will take longer times to infiltrate. Finer powders may be used in infiltration systems wherein increased infiltration times do not affect material properties substantially due to other processes occurring, e.g. evaporation of key material constituents and/or reactions between the infiltrant and the preform. A further constraint comes from the filling of pores by the infiltrant. If the fugitive phase is substantially larger than the skeletal phases, the porosity resulting from the removal of the fugitive phase can be difficult to infiltrate due to the lowering of the capillary pressures to fill the larger pores.

Constraints from the physics of particle packings: If the fugitive phase is substantially smaller than the skeletal phase (the size of fugitive phase particles being less than around four times the size of the skeletal material particles), it will be likely to at least partially occupy the interstitial space between the skeletal powder particles (which would naturally be filled with infiltrant anyway). In powder bed binder jetting printing methods, such an interstitial packing is not desirable from the perspective of being able to tune the volume fraction of infiltrant in the final, infiltrated object, as the fugitive phase is no longer acting as a space holder to prevent the packing of the skeletal material into the space. The same argument can be made for why the fugitive phase particles should not be too much larger than the skeletal material particles—the skeletal material particles should not occupy the interstitial space between the fugitive phase particles. As such, a size ratio of fugitive phase particles to skeletal particles will often be between around ¼ and 4.

Considerations for material properties: In another aspect, many composite material properties improve as the particle size of the reinforcing phase is reduced, and the microstructure is generally refined. In certain instances, a size effect has been reported in the academic literature for the properties of ceramic-reinforced metal composites, with a smaller particle size being preferred for higher strengths. In another example, machinability of metal-matrix composites can be substantially improved if particle sizes of the skeletal material are reduced. By way of illustration, in aluminum-based metal matrix composites reinforced with silicon carbide, when the silicon carbide size is reduced below around 1-5 microns, the machining characteristics improve dramatically. The material properties of the resulting part will in many cases dictate the choice of particle size, with an infiltration process and additive manufacturing process needing to be engineered around this specific particle size.

The above discussion assumed predominantly spherical/equiaxed particles for both the fugitive phase and the skeletal material. The same physics hold for non-equiaxed particles, but the quantitative values will be different for the recommended size ratios, etc.

Combining the above considerations, a particle size between D50=10 and D50=80 are recommended as guidance for the skeletal material, with a fugitive phase powder of around the same particle size, to within around a factor of 3 of the skeletal material.

Another factor is the shape of the fugitive phases. For example, the use of a fibrous fugitive phase may usefully increase the toughness of a material by providing ductile, fracture-arresting elements. Long, thin, localized sections of infiltrant may greatly change the mechanical behavior of the overall part. Control of the density and orientation of such filaments may be limited. In certain embodiments, the deposition of the fugitive phase may be directionally controlled in the power bed or feedstock.

An exemplary system may include that the binder is wax with a fugitive phase of a crosslinked poly(methylmethacrylate) and a skeletal material of aluminum nitride, formed by printing aluminum powder (with small additions of Mg and Sn being preferred to aid in nitriding) that undergoes a nitriding process after chemical debind. The nitriding process requires heating the preform to elevated temperatures (˜540C) in the presence of nitrogen, which simultaneously removes the fugitive phase. After this step, the nitrogen is removed from the atmosphere, before infiltration with 6061 aluminum or a similar aluminum alloy at a temperature of around 700° C.

In another embodiment, the infiltrant is aluminum alloy (6061, 2024, A356, etc.), the skeletal material is nitrided aluminum powder and the fugitive phase is crosslinked PMMA. The binder system includes PMMA as a secondary binder and poly(ethylene glycol) as a primary binder. The primary binder is extracted by water and the secondary binder and fugitive phase are extracted by thermal decomposition.

In another embodiment, the infiltrant is an aluminum alloy (6061, 2024, A356, etc.), the skeletal material is boron carbide and the fugitive phase is sodium chloride. The binder is poly(acrylica acid) binder jetted onto the boron carbide.

Although the disclosed subject matter has been described and illustrated with respect to embodiments thereof, it should be understood by those skilled in the art that features of the disclosed embodiments can be combined, rearranged, etc., to produce additional embodiments within the scope of the invention, and that various other changes, omissions, and additions may be made therein and thereto, without parting from the spirit and scope of the present invention.

What is claimed:

1. A method of fabricating a three-dimensional object of a desired shape, comprising the steps of:
additively manufacturing a composite into the desired shape of the three-dimensional object, the composite including a skeletal phase and a fugitive phase;
performing a fugitive phase removal process to remove the fugitive phase to create a porous skeletal structure; and
infiltrating the porous skeletal structure with an infiltrant to densify the porous skeletal structure into the three-dimensional object.

2. The method of claim 1, wherein the step of additively manufacturing the composite into the desired shape includes powder bed binder jetting additive manufacturing.

3. The method of claim 1, wherein the step of additively manufacturing the composite into the desired shape includes material extrusion additive manufacturing.

4. The method of claim 1, wherein the step of forming the composite into the desired shape includes injection of the composite into a mold.

5. The method of claim 1, wherein the fugitive phase removal process is a thermal process.

6. The method of claim 5 where the fugitive phase is one of a volatile salt, a polymer and an easily-sublimed substance.

7. The method of claim 1, wherein the fugitive phase removal process is a chemical process.

8. The method of claim 7 wherein the fugitive phase is one of a salt soluble in water, a salt soluble in an alcohol, a soluble polymer, and a polymer soluble in a supercritical fluid.

9. The method of claim 1 wherein the fugitive phase removal process is a thermochemical process.

10. The method of claim 9 wherein the fugitive phase is removable via catalytic debinding.

11. The method of claim 1 wherein the skeletal phase is substantially dimensionally stable in the presence of the infiltrant in the environments and timescales of the infiltration process.

12. The method of claim 1 wherein the skeletal phase includes aluminum nitride and the infiltrant includes aluminum.

13. The method of claim 1 wherein the skeletal metal powder includes stainless steel and the infiltrant includes bronze.

14. A material system for the fabrication of infiltrated parts, comprising:
a composite including a skeletal metal powder, a binder system and a fugitive phase;
wherein the binder system is debindable in a debinding process and the fugitive phase is removable in a removal process to form a porous skeletal structure;
an infiltrant;
wherein the skeletal metal powder has a higher melting point than the infiltrant; and
wherein the porous skeletal structure is dimensionally stable in the presence of the infiltrant during an infiltration process effective to infiltrate the porous skeletal structure with the infiltrant.

15. The infiltration material system of claim 14, wherein the infiltrant is wetting with respect to the skeletal metal powder.

16. The infiltration material system of claim 14 wherein the skeletal metal powder includes aluminum nitride and the infiltrant includes aluminum.

17. The infiltration material system of claim 14 wherein the skeletal metal powder includes stainless steel and the infiltrant includes bronze.

18. A method of fabricating a metallic three-dimensional object of a desired shape, comprising the steps of:
forming a composite into the desired shape of the three-dimensional object by depositing a series of successive layers, the composite including a skeletal metal powder, a binder system and a fugitive phase;
debinding the binder system;
performing a fugitive phase removal process to remove the fugitive phase to create a porous skeletal structure; and
infiltrating the porous skeletal structure with an infiltrant to densify the porous skeletal structure into the three-dimensional object.

19. The method of claim 18 wherein the skeletal metal powder includes aluminum and the infiltrant includes aluminum, and further including the step of nitriding the skeletal metal powder prior to the step of infiltrating the porous skeletal structure.

20. The method of claim 18 wherein the skeletal metal powder includes stainless steel and the infiltrant includes bronze.
